(19) United States
(12) Patent Application Publication
(10) Pub. No.: US 2007/0177650 A1
(43) Pub. Date: Aug. 2, 2007

(54) Two-color flame imaging pyrometer

(75) Inventors: John T. Huston, Sugar Grove, OH (US); Simon F. Youssef, Lancaster, OH (US)

Correspondence Address: BRINKS HOFER GILSON & LIONE, P.O. BOX 10395, CHICAGO, IL, 60610, US

(73) Assignee: Diamond Power International, Inc.

(21) Appl. No.: 11/343,653

(22) Filed: Jan. 31, 2006

(51) Int. Cl. G01J 5/00

(52) U.S. Cl. 374/130

(57) ABSTRACT

The system uses a color camera and an optical system to map two colors emitted from an object such as a furnace, boiler combustion zone, or burner flame into a temperature image. The color camera utilizes a color video chip with interspersed pixels for each color to reduce alignment issues and utilize the same optical path. In addition, the optical system utilizes a dual band pass optical filter thereby eliminating the number of optical elements and minimizing radiation loss through the optical system thereby improving the dynamic range of the system.

### BACKGROUND OF THE INVENTION

1. Field of the Invention

The present invention generally relates to a system for optical pyrometry for use in combustion devices.

2. Description of Related Art

Optical pyrometry is a measurement technique in which the temperature of an object or medium is determined based on the spectral radiant emittance of the object or medium. Such techniques are used in various applications, including evaluation of combustion processes and the state of fouling of surfaces within a large scale combustion device. Typically, video pyrometers for such applications utilize two optical paths such that one wavelength band of light is processed down the first optical path and a second wavelength band of light is processed down the second optical path. Each optical path creates two separate images that are focused onto two monochrome video cameras or on two non-overlapping areas of a single monochrome video camera. One such design is provided in U.S. Pat. No. 5,225,893.

In the case of the above-referenced prior art, the coincident optical paths require very precise spatial alignment of the images on the camera or cameras as well as optical path length equalization to ensure proper convergence and focus of the images for dual wavelength pyrometry calculations. Variations in the spatial alignment or optical path length due to misalignment, vibration, and thermal expansion result in large temperature measurement errors and poorly defined images.

In view of the above, it is apparent that there exists a need for an improved system for video pyrometry.

### SUMMARY OF THE INVENTION

In satisfying the above need, as well as overcoming the enumerated drawbacks and other limitations of the related art, the present invention provides an improved system for video pyrometry for use in combustion devices.

The system of this invention uses a color camera and an optical system to map two colors emitted from an object such as a furnace, boiler combustion zone, or burner flame into a temperature image. The color camera utilizes a color video chip with interspersed pixels for each color to reduce alignment issues and utilize the same optical path. An RGB (red-green-blue) or CyGrMgYe (cyan-green-magenta-yellow) color video camera may be readily utilized in the system. In addition, the optical system utilizes a single dual band pass filter thereby eliminating the number of optical elements and minimizing radiation loss through the optical system thereby improving the dynamic range of the system.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a video pyrometry system in accordance with the present invention;

FIG. 2 is a graph illustrating the transmission characteristics of a dual mode band pass filter in accordance with the present invention;

FIG. 3 is a graph of the peak spectral responses for an RGB color camera in accordance with the present invention; and

FIG. 4 is a graph of the peak spectral responses for a CyGrMgYe four color camera in accordance with the present invention.

### DETAILED DESCRIPTION OF THE INVENTION

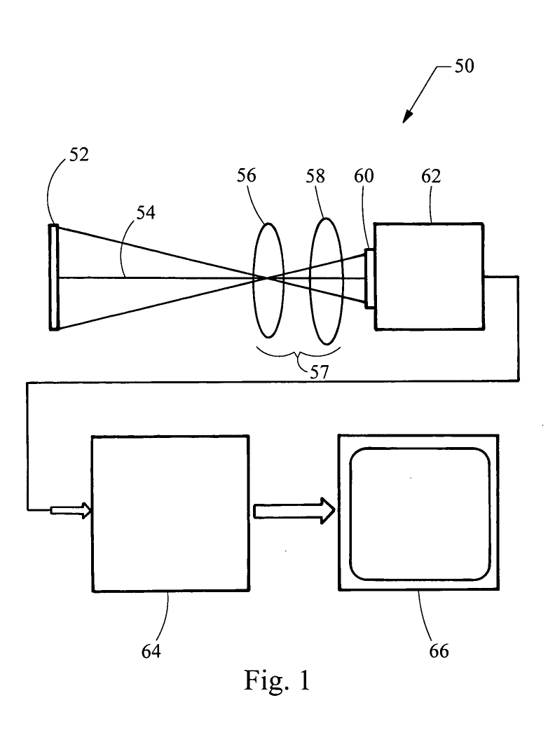

Referring now to FIG. 1, a system embodying the principles of the present invention is illustrated therein and designated at 50. As its primary components, the system 50 includes an optical system 57 and a color video camera 62.

The system 50 provides for remote viewing and an isothermal contour temperature mapping of an object 52, such as a furnace, boiler combustion zones, and burner flames. Although primarily intended for fireside furnace or boiler temperature measurements, the system 50 can also accurately measure temperatures of any object or medium that are radiating within the spectral and illuminance ranges of the color camera 62. The object 52 emits optical radiation as denoted by line 54. The optical radiation 54 is transmitted from the object 52 and is received by the optical system 57.

The optical system 57 includes an objective lens 56 that forms a focused image of the object 52 on the color detector 60 of the color camera 62. The objective lens 56 is in optical communication with a dual band pass filter 58. The dual band pass filter 58 transmits two wavelength bands of light but blocks other wavelengths of light. Light that is transmitted through the dual band pass filter 58 reaches the color detector 60 where it is sensed by the color camera 62. Accordingly, the system 50 does not require two separate optical paths, instead it uses the dual band pass filter 58 and a single optical path to form an image on a single color detector 60 of the color camera 62. Since the two colors are inseparably focused on each pixel of the color camera 62 there is no need for spatial alignment of multiple CCD arrays. Further, since two colors use the same optical path, there is no need for path length equalization.

In addition, the color camera 62 may be a conventional three color RGB (red-green-blue) type camera or the color camera 62 may be a newer four color complementary CyGrMgYe (cyan-green-magenta-yellow) type camera. Each color represents a set of pixels that are sensitive to a certain wavelength band of visible light. Each set of pixels are interspersed in an alternating pattern on the color detector 60 of the color camera 62. Other single detector color cameras having multiple color pixels interspaced may also be substituted for the above-mentioned cameras. However, the above referenced cameras provide a standard interface allowing the two colors to be easily displayed and processed with a variety of hardware and software packages. Although the spectral responses may be different for each type of camera, the dual band pass filter 58 can be designed for the selected camera. In addition, using commonly available color cameras and visible spectrum optics allow low cost and readily available components to be used providing an elegant commercial solution.

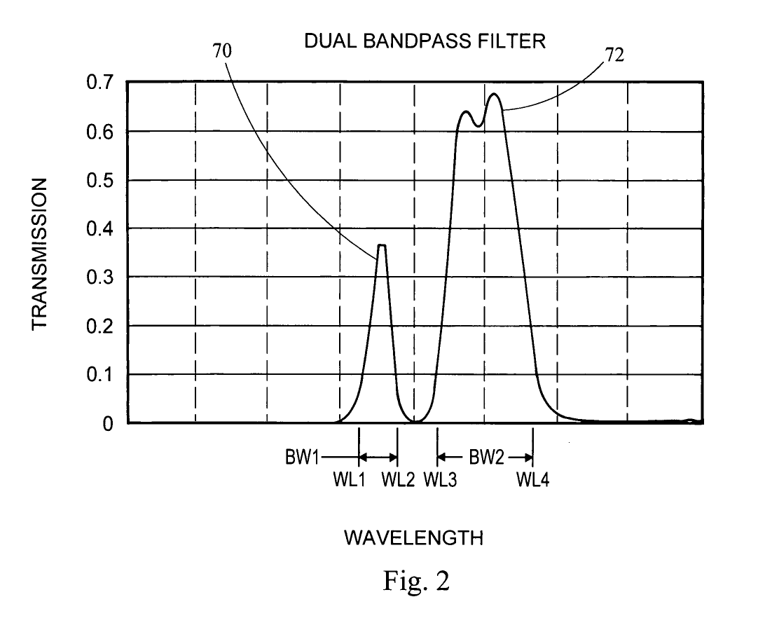

The dual band pass filter 58 is designed to pass two narrow bands, as denoted by reference numerals 70 and 72 in FIG. 2. Each wavelength band 70, 72 may correspond to the sensitivity band of a set of pixels. Further, each band 70, 72 may be more narrow or restrictive than the corresponding sensitivity bands of each set of pixels. Band 70 has a minimum cutoff wavelength of WL1 and a maximum cutoff wavelength of WL2. Accordingly, the bandwidth of band 70 is the range between WL1 and WL2, namely BW1. Similarly, band 72 has a minimum cutoff wavelength of WL3 and a maximum cutoff wavelength of WL4. Accordingly, the bandwidth of band 72 is BW2. The dual band pass filter 58 can be implemented by constructing a special optical filter that passes only the selective wavelength bands or by integrating three separate optical filters into a single optical device, such as a short pass filter, a long pass filter, and a notch filter to generate two modes according to band 70 and band 72. When fabricating the dual band pass filter 58 from three overlaying filters, the short pass filter is selected to pass wavelengths up to the longest wavelength of band 72 (WL4) and the long pass filter is selected to pass wavelengths down to the shortest wavelength of band 70 (WL1). The two filters together form a very wide band pass filter passing all wavelengths between WL1 and WL4. The notch filter is selected to block wavelengths between the longest wavelength of band 70 (WL2) and the shortest wavelength of band 72 (WL3). As such, the notch filter passes wavelengths up to WL2, blocks wavelengths between WL2 and WL3, and passes wavelengths above WL3. The spectral response is the product of the three filters with the center wavelengths of (WL1+WL2)/2 for band 70 and (WL3+WL4)/2 for band 72. Further, the band width BW1 of band 70 is WL2−WL1 and the band width BW2 for band 72 is WL4−WL3. Further, the dual band pass filter may also be fabricated using two filters. For example, one very wide band pass filter may be utilized to pass wavelengths between WL1 and WL4 and a notch filter used to block wavelengths between WL2 and WL3.

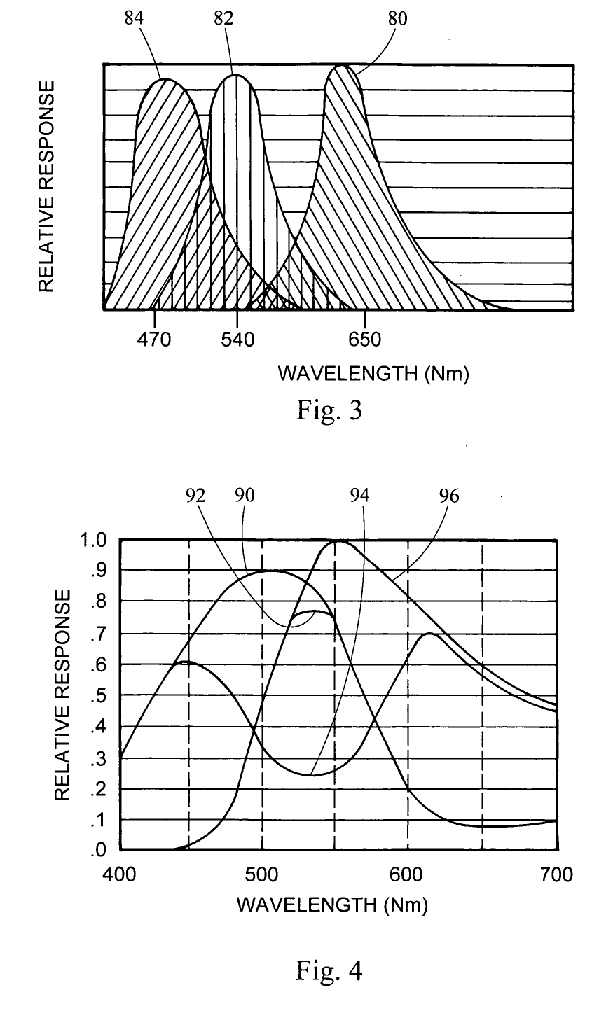

The spectral responses for an RGB color camera are provided in FIG. 3, the spectral response for red is denoted by reference numeral 80, while the spectral responses for green and blue are denoted by reference numeral 82 and 84, respectively. In order to obtain the best optical signal and most accurate color to temperature calculation, the two bands BW1 and BW2, of the dual band pass filter should closely match any two of the color camera spectral peaks. In the case of an RGB type color camera, the peak spectral responses are centered at approximately 470 nanometers for blue, 540 nanometers for green, and 650 nanometers for red. Therefore, the dual band pass filters should be centered at 470 nanometers for band 70 and 540 nanometers for band 72, 470 nanometers for band 70 and 650 nanometers for band 72, or 540 nanometers for band 70 and 650 nanometers for band 72. By limiting the spectral response to the narrow band wavelengths, Plank's law, provided in equation 1 below, may be used to solve for the temperature at each pixel on the color detector 60.
W(λ, T)=ε*C1/(λ⁵*(exp(C2/λT)−1)) (1)
Where,

W(λ, T)—spectral radiant emittance of object or medium,

ε—emissivity of object or medium,

λ—wavelength of radiation,

T—temperature of object or medium, and

C1, C2—constants

For two-color pyrometry, two different wavelengths are selected where the emissivities are either equal or have a constant ratio, yielding two equations:
W₁(λ₁,T)=ε₁*C1/(λ₂⁵*(exp(C2/λ₁T)−1)) (2)
and
W₂(λ₂,T)=ε₂*C1/(λ₂⁵*(exp(C2/λ₂T)−1)) (3)
Where W₁ and W₂ are the measured spectral emittances at the selected wavelengths λ₁ and λ₂ and ε₁ and ε₂ are the emissivities at each respective wavelength.

The simultaneous solution (an algebraic operation) of these equations provides the temperature T since all other terms of these equations are either known or equal.

When relatively short wavelengths are used, such as the visible spectrum (380 to 780 nanometers), the “−1” term can be neglected in both equations allowing a simpler simultaneous solution that yields the single ratiometric equation:
T=(C2*((1/λ₂)−(1/λ₁)))/In((1/λ₁)/(1λ₂)⁵*(W₁/W₂)) (4)
Noting that (C2*((1/λ₂)−(1/λ₁)))/In((1λ₁)/(1λ₂)⁵ is constant for any wavelength pair at all temperatures, the ratiometric equation can be further simplified to:
T=K*(W₁/W₂)) (5)
In the case of two-color video pyrometry, the spatial distribution of temperature can be ascertained by solving for the temperature T for each camera pixel.

The spectral responses for a CyGrMgYe complementary color camera are provided in FIG. 4. The spectral response for cyan is denoted by reference numeral 90, while the spectral responses for green, magenta, and yellow are denoted by reference numerals 92, 94, and 96, respectively. In the case of a complementary color camera, the peak spectral responses are at approximately 450 nanometers and 610 nanometers for magenta, 510 nanometers for cyan, 540 nanometers for green, and 550 nanometers for yellow. Any two of these peak wavelengths can be used for two color temperature calculations. However, for the best color to temperature measurement accuracy, peak wavelengths pairs that have a large response overlap should be avoided. For example, using green and yellow might be difficult due to the large overlap in peak wavelength of the spectral response. However, the following pairs of wavelengths may be effectively used: 450 nanometers and 540 nanometers (Mg and Gr channels), 450 nanometers and 550 nanometers (Mg and Ye channels), 610 nanometers and 510 nanometers (Mg and Cy channels), or 610 nanometers and 540 nanometers (Mg and Gr Channels). The combination of the dual band pass filter 58 along with the internal color filters of the color camera 62 provide a dual wavelength multi-pixel pyrometer that provides the two radiance values W1 and W2 for the simple radiometric equation T=K*(W1/W2) in a standard color video signal format such as RS-170A for each pixel in the field of view. Where K is equal to a constant to adjust for the sensitivity of the system 50 between the two radiance values.

The video processor 64 receives the radiance values W1 and W2 as separate colors in the standard color video signal format and calculates the temperature for each pixel using the simple radiometric equation T=K*(W₁/W₂). Accordingly, the video processor 64 provides a real time isothermal contour map of the temperature distribution of the object 52 as a standard color video signal to the video display 66. Additionally, the video processor utilizes the video signals provided to generate video of the field of view according to one or both of the received colors.

Further, greater than two wavelengths may be used in the same manner as described above and the results combined to provide a temperature measurement. In the case of an RGB color detector, all three channels would be used and a three mode band pass filter would be substituted for the dual mode filter described above.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

I/We claim:

1. A pyrometer system for measuring the temperature of an object emitting light radiation, the pyrometer system comprising:
a color video camera, the color video camera having a color detector including a plurality of picture elements, the plurality of picture elements including a first set of elements configured to detect a first color of light, the second set of elements being configured to detect a second color of light, wherein the first and second set of elements are interspaced on the color detector;
an optical system for focusing optical radiation onto the color detector, the optical system including at least one filter in optical communication with the color detector, the at least one filter transmitting a first band corresponding to the first color of light and a second band corresponding to the second color of light; and
a processor being configured to determine the temperature of the object based on signals from the first and second set of picture elements.

2. The system according to claim 1, wherein the light radiation from the object travels along a single optical path.

3. The system according to claim 1, wherein the color video camera is an RGB color video camera.

4. The system according to claim 4, wherein the at least one filter is configured to block light outside a first and second band and wherein the first band is centered about 470 nanometers and the second band is centered at about 540 nanometers.

5. The system according to claim 4, wherein the at least one filter is configured to block light outside a first and second band and wherein the first band is centered about 470 nanometers and the second band is centered at about 650 nanometers.

6. The system according to claim 4, wherein the at least one filter is configured to block light outside a first and second band and wherein the first band is centered about 540 nanometers and the second band is centered at about 650 nanometers.

7. The system according to claim 1, wherein the color camera is a CyGrMgYe color video camera.

8. The system according to claim 7, wherein the at least one filter is configured to block light outside a first and second band and wherein the first band is centered about 450 nanometers and the second band is centered at about 550 nanometers.

9. The system according to claim 7, wherein the at least one filter is configured to block light outside a first and second band and wherein the first band is centered about 450 nanometers and the second band is centered at about 540 nanometers.

10. The system according to claim 7, wherein the at least one filter is configured to block light outside a first and second band and wherein the first band is centered about 450 nanometers and the second band is centered at about 610 nanometers.

11. The system according to claim 7, wherein the at least one filter is configured to block light outside a first and second band and wherein the first band is centered about 510 nanometers and the second band is centered at about 610 nanometers.

12. The system according to claim 7, wherein the at least one filter is configured to block light outside a first and second band and wherein the first band is centered about 540 nanometers and the second band is centered at about 610 nanometers.

13. The system according to claim 1, wherein the system is configured to calculate the temperature based on the equation T=K*(W₁/W₂)), where T is the temperature of the object, W₁ is the measured spectral emittance of the first set of elements, and W₂ is the measured spectral emittance of the second set of elements.

14. A pyrometer system for measuring the temperature of an object emitting light radiation, the pyrometer system comprising:
a color video camera, the color video camera having a color detector including a plurality of picture elements, the plurality of picture elements including a first set of elements configured to detect a first sensitivity band of visible light, the second set of elements being configured to detect a second sensitivity band of visible light, wherein the first and second set of elements are interspaced on the color detector;
an optical system for focusing optical radiation onto the color detector wherein the optical system includes a dual mode optical filter having a first wavelength band narrower than the first sensitivity band of visible light and a second wavelength band narrower than the second sensitivity band of visible light, and the light radiation from the object travels along a single optical path; and
a processor being configured to determine the temperature of the object based on signals from the first and second set of picture elements.

15. The system according to claim 14, wherein the color video camera is an RGB color video camera.

16. The system according to claim 14, wherein the color camera is a CyGrMgYe color video camera.

17. The system according to claim 14, wherein the system is configured to calculate the temperature based on the equation T=K*(W₁/W₂)), where T is the temperature of the object, W₁ is the measured spectral emittance of the first set of elements, and W₂ is the measured spectral emittance of the second set of elements.
